(19) United States
(12) Patent Application Publication
(10) Pub. No.: US 2012/0124007 A1
(43) Pub. Date: May 17, 2012

(54) Disinfection of a file system

(75) Inventors: Rasmus Sten, Helsinki (FI); Pasi Takala, Helsinki (FI)

(73) Assignee: F-Secure Corporation

(21) Appl. No.: 12/927,520

(22) Filed: Nov. 16, 2010

(51) Int. Cl. G06F 21/00; G06F 17/30; G06F 12/16

(52) U.S. Cl. 707/685; 726/24; 707/E17.005

(57) ABSTRACT

A method of disinfecting an infected electronic file in a file system. At a computer device, a file system is scanned using an anti-virus application to identify the infected electronic file. All or part of an uninfected version of the electronic file is obtained from a backup database of the file system. The backup system includes data from which a plurality of backup copies of at least part of the file system may be obtained. All or part of the infected electronic file is replaced with all or part of the uninfected electronic file. A determination is made as to whether any of the plurality of backup copies include an infected version of the file. If any of the plurality of backup copies include an infected version of the electronic file, the electronic file in the backup database is replaced with all or part of the uninfected version of the electronic file.

### FIELD OF THE INVENTION

The present invention relates to the field of disinfection of a file system.

### BACKGROUND TO THE INVENTION

Virus infection of computers and computer systems is a growing problem. Recently there have been examples where computer viruses have spread rapidly around the world causing many millions of pounds worth of damage in terms of lost data and lost working time.

Computer viruses are spread in many different ways. Early viruses were spread by the copying of infected files onto floppy disks, and the transfer of the file from the disk onto a previously uninfected computer. When the user tries to open the infected file, the virus is triggered and the computer infected. More recently, viruses have in addition been spread via the Internet, for example using e-mail. In the future it can be expected that viruses will be spread by the wireless transmission of data, for example by communications between mobile communication devices using a cellular telephone network.

Various anti-virus applications are available on the market today. These tend to work by maintaining a database of signatures or fingerprints for known viruses. With a “real time” scanning application, when a user tries to perform an operation on a file, e.g. open, save, or copy, the request is redirected to the anti-virus application. If the application has no existing record of the file, the file is scanned for known virus signatures. If a virus is identified in a file, the anti-virus application reports this to the user, for example by displaying a message in a pop-up window. The anti-virus application may then add the identity of the infected file to a register of infected files. Access to the file is denied. When a subsequent operation on the file is requested, the anti-virus application first checks the register to see if the file is infected. If it is infected, the access is denied. If the file is not infected, access is permitted (the anti-virus application may re-check the file if it detects that the file has changed since the previous check was performed).

Once a virus or malware has been detected, the user will typically want the anti-virus application to remove the virus (a process known as disinfection). There are several problems with existing methods of disinfection. Disinfection routines run script or code that attempts to restore the file, and are written for each malware “family” or even each malware variant. However, such routines may end up creating partially disinfected or broken files. Furthermore, even where a disinfection routine works, the digital signature of a disinfected file may be incorrect. This causes a problem for security applications (such as Digital Rights Management) that rely on checking the digital signature of the file.

Furthermore, where the virus modifies Operating System (OS) or application files, the infected files cannot be simply removed as this could cause the associated OS or application to work incorrectly. The virus may also integrate itself into the OS or application by changing registry and system settings, in addition to modifying files.

Some viruses may proxy the legitimate file by saving a copy of the original file and copying itself over it. When the file is required the infected file will be executed rather than the original. However, the infected file may also execute the original file in order to disguise the presence of the infected file in the system. The original file may be hidden or encrypted by the virus in order to make system recovery more difficult. Other viruses operate by infecting the original file such that the virus is activated once the infected file is executed.

In order to disinfect an infected file, an anti-virus application disinfection routine is developed that takes account of the method of infection. However, in some cases a virus might be detected for which a disinfection routine has not yet been developed. This can allow the virus to spread to other systems and cause further damage before it can be disinfected.

It is known (for example from WO 2007/056079) to obtain a clean version of an infected file using a backup. The backup is obtained by taking a snapshot of the file storage volume. However, the file may have been corrupted in the earlier snapshot, in which case previous snapshots must be examined until a clean file can be found. Furthermore, older backups tend to eventually be deleted or only a few older backups may be retained. In a scenario in which an infected file has been stored in the backup for some time, it may be difficult or impossible to find an uninfected version of the infected file in the stored backups.

A further problem arises when using an incremental backup system such as Time Machine®. Incremental backups operate by creating a backup of an entire file system. After a predetermined time period (say, one hour), a further backup is created that only contains back ups of files that have changed since the earlier file was created, and links to unchanged files in the earlier backup. This allows much more efficient storage of backup files that can subsequently be accessed, and a snapshot of the file system at a given point in time can be determined. This increases the difficulty of identifying the uninfected version of a file.

### SUMMARY OF THE INVENTION

It is an object of the invention to provide improved methods for disinfecting infected electronic files in a client system and for repairing any damage caused by in infection.

According to a first aspect of the invention, there is provided a method of disinfecting an infected electronic file in a file system. At a computer device, a file system is scanned using an anti-virus application to identify the infected electronic file. All or part of an uninfected version of the electronic file is obtained from a backup database of the file system. The backup system includes data from which a plurality of backup copies of at least part of the file system may be obtained. All or part of the infected electronic file is replaced with all or part of the uninfected electronic file. A determination is made as to whether any of the plurality of backup copies include an infected version of the file. In the event that any of the plurality of backup copies include an infected version of the electronic file, all or part of the infected version of the electronic file in the backup database is replaced with all or part of the uninfected version of the electronic file.

The backup database may be of the sort that comprises incremental backup data. Incremental backup data comprises a first backup of all or part of the file system and a plurality of subsequently obtained backups. Each subsequently obtained backup comprises backups of any files in the file system that have changes from the files stored in the first backup, and links to files in the first backup that have not changed.

Alternatively, the backup database may comprise a plurality of backups of all or part of the file system, each backup of the plurality of backups being obtained at a different time.

In an optional embodiment, the backup database is located remotely from the computer device.

The method may further comprise determining a time when the infected electronic file was likely to have been infected, and selecting a backup copy containing the uninfected electronic file from before the determined time.

As an option, the method may comprise determining a time when the infected electronic file was likely to have been infected, determining which files have changed in a subsequent backup after the determined time, and analysing the corresponding files in the file system to determine whether they have been affected by the infected file.

According to a second aspect, there is provided a method of restoring electronic files affected by an infection in a file system. At a computer device, the file system is scanned using an anti-virus application to identify an infected electronic file. A time when the infected electronic file was likely to have been infected is determined. A backup database of the file system is queried, the query instructing a search of electronic files in the database that changed after the determined time of infection. All or part of unchanged versions of files stored in the backup database at a time before the determined time of infection that subsequently changed after the determined time of infection from the backup database are obtained. All or part of the changed electronic files in the file system are replaced with all or part of the unchanged versions of the electronic files. In this way, changes caused by an infection can be quickly repaired with no or a minimum of input from a user. The user does not need to manually replace affected electronic files as this can be performed automatically.

The method may further comprise analysing other electronic files in the file system that correspond to backups in the database of electronic files that changed after the determined time of infection and determining whether they are infected.

The method may further comprise replacing infected electronic files stored in the backup database with uninfected versions of those electronic files. This ensures that the database is clean and can be used to repair affected files in the event of any future infections.

The backup database may be of the sort that comprises incremental backup data. The incremental backup data comprises a first backup of all or part of the file system and a plurality of subsequently obtained backups. Each subsequently obtained backup comprises backups of any electronic files in the file system that have changes from the files stored in the first backup, and links to electronic files in the first backup that have not changed.

The method may further comprise, prior to replacing all or part of the changed electronic files in the file system with all or part of the unchanged versions of the electronic files, seeking a response from user to allow or deny the replacement. This feature is to ensure that electronic files that have changed since the determined time of infection for legitimate reasons are not replaced.

According to a third aspect, there is provided a computer program, comprising computer readable code which, when run on a computer device, causes the computer device to perform the method described above in the first aspect.

According to a fourth aspect, there is provided a computer program, comprising computer readable code which, when run on a computer device, causes the computer device to perform the method described above in the second aspect.

According to a fifth aspect, there is provided a computer program product comprising a computer readable medium and a computer program as described above in the third aspect, wherein the computer program is stored on the computer readable medium.

According to a sixth aspect, there is provided a computer program product comprising a computer readable medium and a computer program as described above in the fourth aspect, wherein the computer program is stored on the computer readable medium.

### BRIEF DESCRIPTION OF THE DRAWINGS

FIG. 1 illustrates schematically in a block diagram a network architecture according to a embodiments of the invention showing two alternative backup databases;

FIG. 2 is a flow diagram illustrating a mechanism for disinfecting an infected electronic file stored in a file system according to first and second embodiments of the invention; and

FIG. 3 is a flow diagram illustrating a mechanism for repairing the effects caused by an infection in a file system according to a third embodiment of the invention.

### DETAILED DESCRIPTION OF CERTAIN EMBODIMENTS

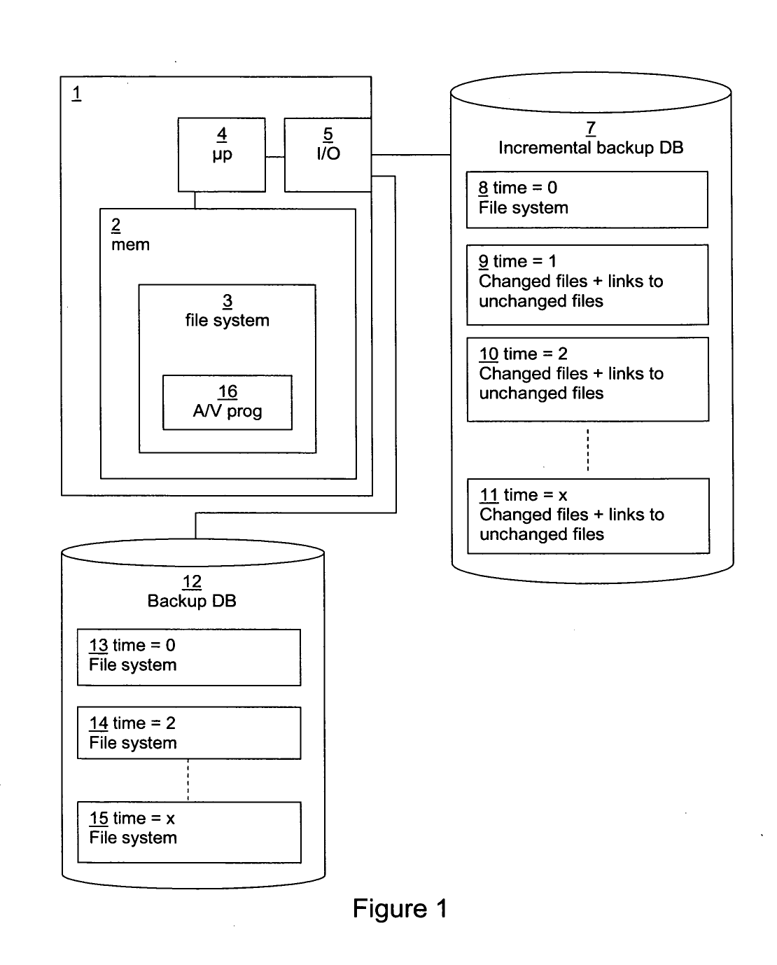

Referring to FIG. 1, there is illustrated a computer device 1. The computer device 1 may be any type of computer device, such as a desktop personal computer, a laptop computer, a mobile telephone, a Personal Digital Assistant (PDA) and so on. The computer device has a computer readable medium in the form of a memory 2 in which files are stored in a file system 3 A program 4 required to run an anti-virus scan may be stored as part of the file system 3. The memory 2 may be any writable medium in which files can be stored, such as a hard disk, a Random Access Memory, a flash disk and so on. Furthermore, whilst the memory 2 may be integral with the client device 1 it may also simply be connected to the client device 1. An example of a memory 2 connected to a computer device is a hard disk connected via a USB connection to a desktop personal computer. A processor 4 is provided for running an anti-virus application and scanning the file system 3 stored in the memory 2. In addition, an I/O device 5 is provided for allowing the client device 1 to communicate with remote nodes.

In a first embodiment, an incremental backup database 7 is illustrated, connected to the computer device via the I/O device 5. The backup database is illustrated in this example as an external memory such as an external hard drive, connected by a USB port, although it will be appreciated that any type of memory may be used, and the backup may be stored on a separate internal memory or even on the memory 2 in the computer device 1. The incremental backup database 7 contains a snapshot 8 of the file system when a first backup was obtained. After a first time interval, a copy 9 is made of any files that have changed since the snapshot 8 was obtained, along with links to the unchanged files in the snapshot 8. After a second time interval, a copy 10 is made of any files that have changed since the snapshot 8 was obtained, along with links to the unchanged files in the snapshot 8. Further copies 11 are made after further time intervals.

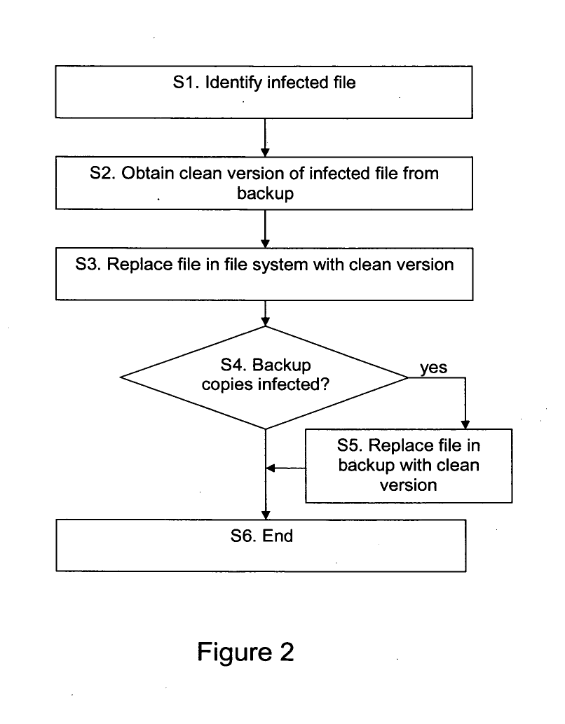

Turning now to FIG. 2, when an anti-virus application 16 is executed, the file system 3 is scanned for viruses. The following steps then apply:

S1. One or more infected files are identified in the file system 3. The infected file may be identified by any of a number of known methods, such as looking for the signature or fingerprint of a virus.

S2. The anti-virus application 16 queries the incremental backup database 7 to obtain an uninfected version of the infected electronic file. It is preferred that the version obtained is the most recent available uninfected version of the electronic file.

S3. The infected file in the file system 3 is replaced with the uninfected version of the file obtained from the incremental backup database 7. With an incremental backup database, only different versions of the infected electronic file need be changed, as subsequent backups might include links to the same version; by only replacing each infected version of the electronic file with an uninfected version, all the links in subsequent backups will refer to the uninfected version.

S4. A determination is made to find out whether any versions of the file stored in the incremental backup database 7 are infected. If not then the process ends at step S6.

S5. If it is determined that there are infected versions of the electronic file stored at the incremental backup database 7, then those versions are replaced with the infected version to ensure that the backup database is free of infected versions of the electronic file.

According to a second embodiment, also illustrated in FIG. 1, a backup database 12 is used that stores a plurality of snapshots 13, 14, 15 of the file system 3. Each snapshot 13, 14, 15 is of the complete file system 3 at a given time. The second embodiment of the invention is very similar to the first embodiment of the invention, except that the versions of the infected file in each snapshot must be replaced with the uninfected version of the file.

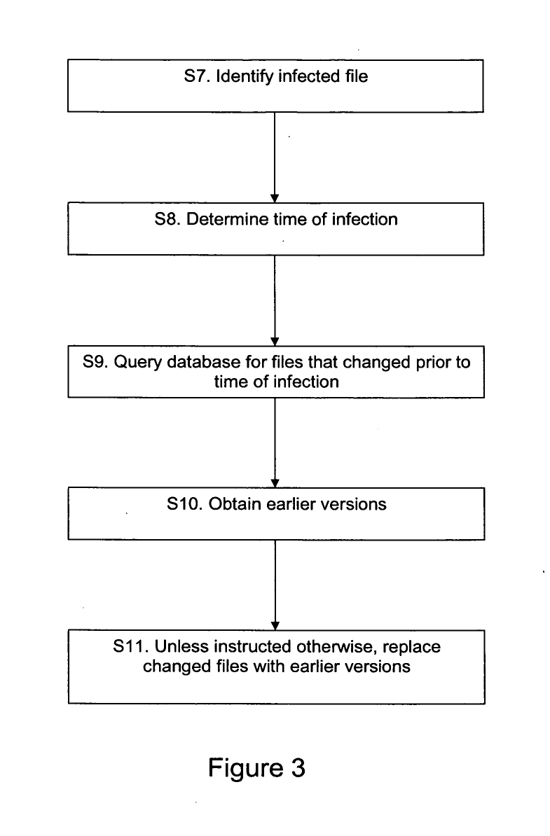

Turning now to FIG. 3, there is shown a flow diagram of the steps for repairing the effects caused by an infection in a file system according to a third embodiment of the invention. While the third embodiment of the invention may be used in isolation, it is also compatible with the first embodiment of the invention. The description of the third embodiment of the invention given below uses the example of a system that uses an incremental backup database, but it will be appreciated that this embodiment is also compatible with a “snapshot” type of database as described in the second specific embodiment.

S7. One or more infected files are identified in the file system 3. The infected file may be identified by any of a number of known methods, such as looking for the signature or fingerprint of a virus.

S8. The time when the file was infected is determined. This may be done by, for example, analysing creation and/or modification time stamps associated with the file, or looking at time the first infected file was stored in the incremental backup database 7.

S9. The incremental backup database 7 is queried to determine which files changed after the determined time of infection. Some files may have been changed as a result of the infection. For example, malware may change all the text in a text document. In this case, the text document has not been infected, but it has been affected by the infected file. Another example is where malware alters a schedule used by a task scheduler in order to initiate a specific service. In this case, the schedule has not been infected, but it has been affected by the infected file.

S10. An earlier version of the each file that has been affected by the infection is obtained from the copies of the files stored in the incremental backup database 7 that were changed after the infection occurred. This ensures that the earlier versions are obtained from files that have not been affected by the infection.

S11. Any files in the file system 3 are replaced with the unaffected version of the file obtained from the incremental backup database 7. In an optional embodiment, a before replacing a file with an unaffected version, the user may be given the option to manually override the replacement operation. This is because some electronic files may have changed as a result of legitimate operations that are not connected to the infection, and the user may wish to keep the changed electronic files. By giving the user a manual override option, the user can decide which electronic files are replaced and which are not.

It will be appreciated that this embodiment allows fast identification of earlier versions of files that have been affected by an infected electronic file. Furthermore, the backup database can then be changed to replace affected versions of a file with an earlier, unaffected version of the file. Furthermore, it allows the damage caused to electronic files by an infected file to be fixed quickly and accurately. Note that in this case, it may be possible to obtain and replace portions of electronic files that changed and were affected by the infected electronic file.

The invention reduces the need for running a script to disinfect an infected file in a file system, as the infected portions of the file are simply replaced. This means that problems associated with scripts that only partially work are overcome. Furthermore, a script for repairing an infected file need not be written, as it is simply enough to identify that a file is infected. The file can be disinfected immediately, thereby overcoming problems associated with waiting for a suitable script to be provided by the ant-virus application provider. By disinfecting the backup database, it is less likely that the backup database will become corrupted and only contain infected versions of certain files. By determining the time of infection, the searching of an incremental backup database can be performed much more quickly than would otherwise be the case, and files that have been affected by an infection can be identified and repaired in the file system.

It will be appreciated by the person of skill in the art that various modifications may be made to the above described embodiment without departing from the scope of the present invention.

1. A method of disinfecting an infected electronic file in a file system, the method comprising:
at a computer device, scanning the file system using an anti-virus application to identify the infected electronic file;
obtaining all or part of an uninfected version of the electronic file from a backup database of the file system, the backup system comprising data from which a plurality of backup copies of at least part of the file system may be obtained;
replacing all or part of the infected electronic file with all or part of the uninfected electronic file;
determining whether any of the plurality of backup copies include an infected version of the file; and
in the event that any of the plurality of backup copies include an infected version of the electronic file, replacing all or part of the infected version of the electronic file in the backup database with all or part of the uninfected version of the electronic file.

2. The method according to claim 1 wherein the backup database comprises incremental backup data, the incremental backup data comprising a first backup of all or part of the file system and a plurality of subsequently obtained backups, each subsequently obtained backup comprising backups of any files in the file system that have changes from the files stored in the first backup, and links to files in the first backup that have not changed.

3. The method according to claim 1, wherein the backup database comprises a plurality of backups of all or part of the file system, each backup of the plurality of backups being obtained at a different time.

4. The method according to claim 1, wherein the backup database is located remotely from the computer device.

5. The method according to claim 1, further comprising determining a time when the infected electronic file was likely to have been infected, and selecting a backup copy containing the uninfected electronic file from before the determined time.

6. The method according to claim 2, further comprising:
determining a time when the infected electronic file was likely to have been infected;
determining which files have changed in a subsequent backup after the determined time; and
analysing the corresponding files in the file system to determine whether they have been affected by the infected file.

7. A method of restoring electronic files affected by an infection in a file system, the method comprising:
at a computer device, scanning the file system using an anti-virus application to identify an infected electronic file;
determining a time when the infected electronic file was likely to have been infected;
querying a backup database of the file system, the query instructing a search of electronic files in the database that changed after the determined time of infection;
obtaining all or part of unchanged versions of files stored in the backup database at a time before the determined time of infection that subsequently changed after the determined time of infection from the backup database; and
replacing all or part of the changed electronic files in the file system with all or part of the unchanged versions of the electronic files.

8. The method according to claim 7, further comprising analysing other electronic files in the file system that correspond to backups in the database of electronic files that changed after the determined time of infection and determining whether they are infected.

9. The method according to claim 7, further comprising replacing infected electronic files stored in the backup database with uninfected versions of those electronic files.

10. The method according to claim 7, wherein the backup database comprises incremental backup data, the incremental backup data comprising a first backup of all or part of the file system and a plurality of subsequently obtained backups, each subsequently obtained backup comprising backups of any electronic files in the file system that have changes from the files stored in the first backup, and links to electronic files in the first backup that have not changed.

11. The method according to claim 7, further comprising, prior to replacing all or part of the changed electronic files in the file system with all or part of the unchanged versions of the electronic files, seeking a response from user to allow or deny the replacement.

12. A computer program, comprising computer readable code which, when run on a computer device, causes the computer device to perform the method of claim 1.

13. A computer program, comprising computer readable code which, when run on a computer device, causes the computer device to perform the method of claim 7

14. A computer program product comprising a computer readable medium and a computer program according to claim 12, wherein the computer program is stored on the computer readable medium.

15. A computer program product comprising a computer readable medium and a computer program according to claim 13, wherein the computer program is stored on the computer readable medium.
